(19) United States
(12) Patent Application Publication
(10) Pub. No.: US 2011/0078715 A1
(43) Pub. Date: Mar. 31, 2011

(54) IDENTIFYING A MOVIE OF INTEREST FROM A WIDGET USED WITH MOVIE COMMERICIALS

(75) Inventors: DAVID D. CHUNG, Santa Clara, CA (US); Walter R. Klappert, Los Angeles, CA (US)

(73) Assignee: Rovi Technologies Corporation, Santa Clara, CA (US)

(21) Appl. No.: 12/569,535

(22) Filed: Sep. 29, 2009

(51) Int. Cl. H04H 60/33

(52) U.S. Cl. 725/9; 725/25; 725/32

(57) ABSTRACT

A user is provided with data and/or other interactive features based on their interaction with a widget running on user equipment. User permissions, user profiles, and other options related to the widget may be aggregated by a central processor. The user may invoke the widget during a movie commercial, and the processor may use the information it has gathered to identify the exact movie related to the movie commercial. This resolution may be based on the time the user invoked the widget, as well as the programming schedule the user watched during broadcast of the movie commercial. The user may be provided with data and/or other interactive features from a third party based on the movie of interest.

### BACKGROUND OF THE INVENTION

Widgets are programs that provide information from the Internet to a user through web services, and run on televisions and/or user equipment associated with televisions. Television widgets are widgets that run strictly on the hardware platform (e.g., control circuitry) of a television. Typically, television widgets have limited interactions with external user equipment and databases, such as set top boxes and third party servers. Further, television widgets have a limited amount of resources available to gauge a user's interest in information that appears on the television.

Service providers and/or other third parties desire widgets that provide meaningful data and/or other interactive features to users of television widgets related to products in advertisements that the user is interested in. Accordingly, there is a need for television widgets that overcome these limitations to provide these services. In particular, there is a need for a television widget that can identify a movie of interest and provide movie related data and/or other interactive features based on user interactions with the widget during a commercial for the movie of interest.

This movie-related data and/or other interactive services may include the delivery of information from a movie studio or cinema club's server of movie viewing times related to the movie of interest, the purchase of a movie ticket for viewing the movie of interest in a cinema, the rental of the movie of interest from a physical video store, the rental or download of the movie of interest from a suitable digital media delivery service, and/or any other suitable movie-related data and/or other interactive features. Although the invention will be described in the context of a widget used with an advertisement for a movie to provide movie related data and/or other interactive features, the invention may also be used to provide any data and/or interactive features related to a product featured in an advertisement, such as a television program, video game title, music album or compilation, or any other suitable product which can be advertised and associated with related data and/or interactive features.

### SUMMARY OF THE INVENTION

Methods and systems for using a widget to provide movie-related data and/or other interactive features when an advertisement for the movie runs on a user's television set are provided in accordance with various embodiments of the present invention.

In some embodiments, a user may enter information into a system that is related to their permissions for sharing their viewing habits with the widget, as well as a user profile that details their relationship with customer service providers (e.g., their cable television service and their online video rental accounts). This information may be entered at any internet-enabled device available to the user, including the widget itself. The user may also begin to use the widget by providing login credentials. This login may provide the user with a unique identification code that the user can provide to various devices in the system such that their information is aggregated at a central processor.

The user may then watch broadcast television as normal. When the user sees a movie commercial that they are interested in, they may indicate their interest in the movie by invoking the widget using, for example, their remote controller.

Once the user has indicated their interest in the movie in this manner, the system may begin to identify the particular movie the user was interested in. This identification may be based on the time and date the user invoked the widget (i.e., at the same time and date that a commercial related to the movie was broadcast), and the information they entered regarding their user profile and permissions. The central processor may aggregate this information and navigate the exchange of data between various servers in order to identify the movie of interest. This process is largely seamless to the user, although they may be prompted for additional information to aid in the identification of the movie of interest.

Once the system has identified the movie of interest, it may send an identifier related to the movie of interest to a third party server based on the user's permissions. The user may then be provided with movie-related data and/or other interactive features, for example movie showing times related to the movie of interest, based on responses from the third party server.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1. illustrates an example of a system for providing movie related data and/or other interactive features from a widget in accordance with some embodiments of the present invention;

FIG. 2 illustrates an example of user equipment devices that may be used to implement the television widget in accordance with some embodiments of the present invention;

FIG. 3 illustrates an example of a profile setup screen used to provide data and/or other interactive features to the user through the television widget in accordance with some embodiments of the present invention;

FIG. 4 illustrates an example of a login screen used to provide data and/or other interactive features to the user through the television widget in accordance with some embodiments of the present invention;

FIG. 5 illustrates an example of a user permissions screen used to provide data and/or other interactive features to the user through the television widget in accordance with some embodiments of the present invention;

FIG. 6 illustrates an example of user viewing data in accordance with some embodiments of the invention;

FIG. 7 illustrates an example of a user identification screen used to aid the television widget in identifying a movie of interest in accordance with some embodiments of the present invention;

FIG. 8 illustrates an example of a television widget notification screen in accordance with some embodiments of the present invention;

FIG. 9 illustrates a flow chart of a process for providing at least one of data and interactive features based on user interaction with a television widget in accordance with some embodiments of the present invention; and

FIG. 10 illustrates a flow chart of a process for identifying a movie of interest based on user interaction with a television widget in accordance with some embodiments of the present invention.

### DETAILED DESCRIPTION OF THE VARIOUS EMBODIMENTS

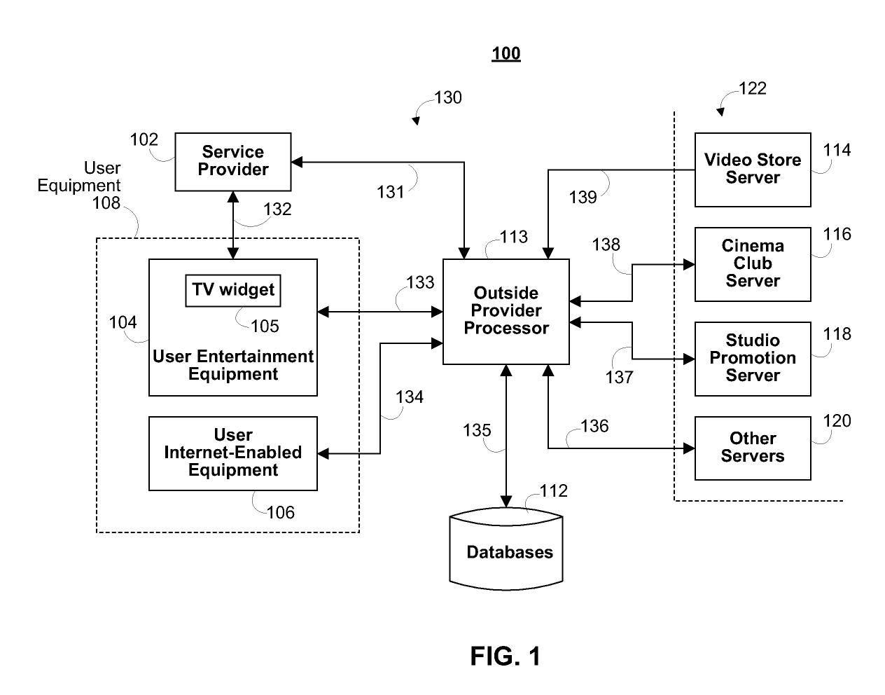

FIG. 1 illustrates an example of a system 100 for providing movie related data and/or other interactive features from a widget in accordance some embodiments of the present invention. In some embodiments, television widget 105 may be resident in user entertainment equipment 104 within user equipment 108. User equipment 108 may include both user entertainment equipment 104 and user internet-enabled equipment 106.

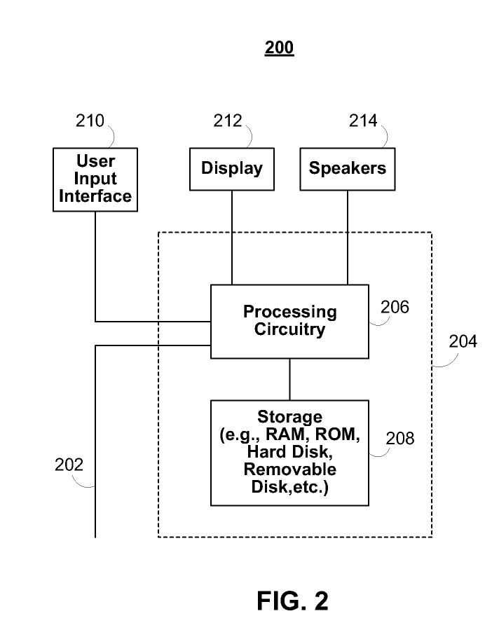

Television widget 105 is an application that is downloaded or installed in user entertainment equipment 104, and may be run by an interpreter or virtual machine (run by the control circuitry of user entertainment equipment 104—see control circuitry 204 in FIG. 2, below). Television widget 105 allows users to interact with web services while watching television on user entertainment equipment 104. In some embodiments, television widget 105 may run on the Yahoo! Connected TV platform, and user entertainment equipment 104 may be a television manufactured with built-support for television widget 105 from one of Samsung Group, Sony Group, LG Electronics, or Vizio.

In other embodiments, the television widget may be downloaded and interpreted or otherwise run by an interpreter or virtual machine (run by control circuitry 204). In some embodiments, the guidance application may be encoded in the ETV Binary Interchange Format (EBIF), received by control circuitry 204 as part of a suitable feed, and interpreted by a user agent running on control circuitry 204. For example, television widget 105 may be a EBIF widget and user entertainment equipment 104 may be a set-top box. In other embodiments, the television widget may be defined by a series of JAVA-based files that are received and run by a local virtual machine or other suitable middleware executed by control circuitry 204. In some of such embodiments (e.g., those employing MPEG-2 or other digital media encoding schemes, the guidance application may be, for example, encoded and transmitted in an MPEG-2 object carousel with the MPEG audio and video packets of a program. In the example, television widget 105 may be an OCAP widget (e.g., a tru2way widget), and user entertainment equipment 104 may be a set-op box.

In other embodiments, user entertainment equipment 104 may include a user television equipment, user computer equipment, a wireless user communication device, a set-top box, or any other type of user entertainment equipment for accessing media, such as a non-portable gaming machine.

In some embodiments, the user may enter settings information, such as user profile information and user permissions information, into user internet-enabled equipment 106. Assuming that the user sets their permissions such that user profile information may be stored externally, the user profile information may be stored in databases 112. User internet-enabled equipment 106 may include a set-top box, an integrated receiver decoder (IRD) for handling satellite television, a PC, a laptop, a tablet, a WebTV box, a personal computer television (PC/TV), a PC media server, a PC media center, a television set, a digital storage device, a DVD recorder, a video-cassette recorder (VCR), a local media server, wireless user communications devices, or any other suitable internet-enabled equipment. WEBTV is a trademark owned by Microsoft Corp. Wireless communications devices may include PDAs, a mobile telephone, a smartphone, a portable music player, a portable gaming machine, or other wireless devices.

In system 100, there is typically more than one of each type of user equipment device but only one of each is shown in FIG. 1 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

It should be noted that with the advent of television tuner cards for PC's, WebTV, and the integration of video into other user equipment devices, the lines have become blurred when trying to classify a device as a user entertainment device or a user internet-enabled device. In fact, in some embodiments television widget 105 may run on user internet-enabled equipment 106 in addition to user entertainment equipment 104, and settings information may be entered using either type of user equipment. Each of user equipment 108 may utilize at least some of the system features described below with respect to FIG. 2 and, as a result, include flexibility with respect to the type of interactive applications available on the device. For example, user entertainment equipment 104 may be internet-enabled allowing for access to settings information through the Internet, while user internet-enabled equipment may include a tuner allowing for access to television programming, and both may run television widget 105. The television widget may have the same layout on the various types of user equipment or may be tailored to the display capabilities of the user equipment. For example, on user entertainment equipment 104, television widget 105 may run as a persistent (e.g., always-running) application as described above. In another example, television widget may be scaled down for wireless user communications devices.

The settings information entered by the user may be consistent across in-home devices and remote devices. Settings include those user profile and user permission settings described herein, as well as channel and program favorites, programming preferences, display preferences, and other desirable guidance settings. For example, if a user sets a channel as a favorite on, for example, the web site www.tvguide.com on their personal computer at their office, the same channel would appear as a favorite on the user's in-home devices (e.g., user entertainment equipment 104 and user internet-enabled equipment 106). Therefore, changes in user profile or user permissions settings made on one user equipment device can change the user's experience on another user equipment device, regardless of whether they are the same or a different type of user equipment device. In addition, the changes made may be based on settings input by a user, as well as user activity monitored by television widget 105.

The user equipment devices of user equipment 108 may be coupled to communications network 130. Namely, user entertainment equipment 104 and user internet-enabled equipment 106 may be coupled to communications network 130 using communications paths 133 and 134, respectively. Communications network 130 may be one or more networks including the Internet, a mobile phone network, mobile device (e.g., Blackberry) network, cable network, public switched telephone network, or other types of communications networks. BLACKBERRY is a service mark owned by Research In Motion Limited, Corp. Paths 131-139 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the user equipment devices may be provided by one or more of these communications paths, but are shown as a single paths in FIG. 1 to avoid overcomplicating the drawing.

Although communications paths are not drawn between user equipment devices, these devices may communicate directly with each other via communication paths, such as those described above in connection with paths 131-139, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 130.

When a movie-related commercial runs on user entertainment equipment 104, the user may invoke television widget 105 to express his or her interest in the movie. As a result, television widget 105 may send information to service provider 102 over communications link 132 and/or outside provider processor 113 (hereinafter “OPP 113”) over communications link 133. In some embodiments, databases Communications with service provider 102 and OPP 113 may be exchanged over one or more communications paths, but are shown as two separate paths in FIG. 1 to avoid overcomplicating the drawing. In addition, there may be more than one of each of service provider 102 and OPP 113, but only one of each is shown in FIG. 1 to avoid overcomplicating the drawing. As will be described, the information television widget 104 sends to these sources may be as little as an identification number, the channel the user is watching, and the time and date the user invoked the widget.

Service provider 102 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Service provider 102 may be the originator of media content (e.g., a television broadcaster, a Webcast provider, a digital cable service provider, a bundled communication (e.g., Internet, telephone, and TV) provider such as Verizon FiOS, a provider of digital on-demand media affiliated with a movie studio or television network, a cellular telephone service provider, etc.) or may not be the originator of media content (e.g., an on-demand media content provider, an Internet provider of video content of broadcast programs for downloading, etc.). Service provider 102 may include cable sources, satellite providers, on-demand providers, Internet providers, or other providers of media content. Service provider 102 may also include a remote media server used to store different types of media content (including video content selected by a user, such as, for example, on the website www.hulu.com), in a location remote from any of the user equipment devices. As used herein, the term broadcaster may refer to an analog or digital signal provider, a cable network, a satellite provider, an Internet website, an Internet content provider, or any such provider that may distribute content such as programs or program segments to user equipment or user equipment devices. As used herein, the terms broadcaster's website or program broadcaster's website may refer to one or many web addresses, server addresses, databases, or other sources of program information or program content, specific to a particular broadcaster, and associated with Internet websites or other content providers. Systems and methods for remote storage of media content, and providing remotely stored media content to user equipment are discussed in greater detail in connection with Ellis et al., U.S. patent application Ser. No. 09/332,244 (Attorney Docket No. UV-084), filed Jun. 11, 1999, which is hereby incorporated by reference herein in its entirety.

Service provider 102 may also provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips or segments, etc.), on-demand information, and any other type of guidance data that is helpful for a user to navigate among and locate desired media selections.

OPP 113 may include a data processor (e.g., any suitable computer server equipment) operated by an outside provider (e.g., the provider of television widget 105) that can act as a central hub for communications between television widget 105 running on user equipment 108, service provider 102, and third party servers 122. As will be discussed, third party servers 122 may include video store server 114, cinema club server 116, studio promotion server 118, and other servers 120. In some embodiments, OPP 113 may store and retrieve information from databases 112. Databases 112 may be any suitable computer server equipment, and may include any suitable computer storage devices.

In some embodiments, OPP 113 may identify the name of the movie a user of television widget 105 had interest in when they invoked the widget. To achieve this function, OPP 113 may exchange information with service provider 102 via communication link 131, user equipment 108 via communication links 133 and 134, and databases 112 via communication link 135. In an embodiment, OPP 113 may identify the name of a movie of interest based on a user's profile information set on user equipment 108 and stored in databases 112, as well as scheduling information obtained from service provider 102. In some embodiments, this identification may be made by service provider 102 itself.

In some embodiments, OPP 113 may act as a clearinghouse of information for providing data and/or other interactive features to the user of television widget 105. To achieve this function, OPP may exchange information with third party servers 120 via communication links 136-139. For example, OPP 113 can continuously receive movie show time information from cinema club server 116 via communication link 138, and receive inventory and other information from video store server 114 via communication link 139. OPP 113 may then provide data and/or other interactive features related to a movie of interest to a user based on their interaction with television widget 105 and user profile information stored in databases 112. More specifically, OPP 113 could determine what movies the user is interested in based on their interaction with television widget 105, determine that the user prefers movie rentals over watching the movie in a theatre based on profile information stored in databases 112, and then determine the best deal on a DVD purchase based on information from video store server 114. OPP may then pass on recommendations from video store server 114 for DVD rentals to the user based on their interaction with television widget 105, profile information stored in databases 112, and DVD rental inventory from video store server 114.

In some embodiments, OPP 113 may complete transactions between a user of television widget 105 and third party servers 122. For example, OPP 113 could determine the best deal on a DVD purchase from competing third parties related to a movie the user indicated interest in while interacting with television widget 105. With the customer's permission, OPP 113 may automatically purchase the DVD using the user's credit card information entered by the user through television widget 105 or previous entered by the user and stored in databases 112 with the user's permission.

In some embodiments, this data and/or other interactive features may be provided in the form of visual information (e.g., text and/or pictures and/or video) delivered to user equipment 108 and displayed in television widget 105. In other embodiments, this visual information may be provided to the user through particular features of user equipment 108 outside of the functionality of television widget 105.

In some embodiments, the two above-mentioned functions may be achieved by OPP 113 accessing information directly from service provider 102 via communication link 131. In other embodiments, the two above-mentioned functions may be achieved by OPP 113 accessing information from service provider 102 in a two-step process. For example, service provider 102 may provide information to user equipment 108 via communication link 132, and television widget 105 may then deliver this information to OPP 113 via communication link 133. This two-step process may be useful when there is an agreement to share information between service provider 102 and advertising sources (i.e., those buying advertising from service provider 102).

Video store server 114 may include may include any suitable computer server equipment operated by a proprietor of video media, either physical or digital. Such video stores may include Blockbuster Video, Hollywood Video, Netflix, Apple iTunes, and Amazon.com. In some embodiments, video store server 114 may send inventory and other information to OPP 113 via communication link 139. For example, video store server 114 may send OPP 113 information regarding available video-demand, digital download, or physical DVD media titles for rent or purchase that are related to a movie that a user expressed interest in through interaction with television widget 105.

Cinema club server 116 may include any suitable computer server equipment operated by a proprietor of movie theatres, such as AMC Entertainment Inc., Carmike Cinema, Clearview Cinema, Landmark Theatres, or Regal Entertainment Group. In some embodiments, cinema club server 116 may send information regarding movie screenings, such as movie times, special movie screening promotions, or any other events at a particular movie theatre that are related to a movie that a user expressed interest in through interaction with television widget 105.

Studio promotion server 118 may include any suitable computer server equipment operated by the promotional department or wing of a movie studio, such as Warner Brothers, Dreamworks, 20th Century Fox, or MGM. In some embodiments, studio promotion server 118 may send information regarding movie screenings, such as movie times, special movie screening promotions, downloadable content, online games, or online experiences such as chat sessions related to a movie that a user expressed interest in through interaction with television widget 105.

Other servers 120 may include any suitable computer server equipment not mentioned in the description above. For example, other servers 120 may include movie-related websites such as imdb.com, comingsoon.net, or boxofficemojo.com. In some embodiments, other servers 120 may send information regarding actors, directors, producers, trivia, box office take, or other suitable information related to a movie that a user expressed interest in through interaction with television widget 105.

In some embodiments, video store server 114, cinema club server 116, studio promotion server 118, or other servers 120 may respond to requests from OPP 113 to identify a movie of interest using, for example, a search of its inventory database. In other embodiments, these servers may periodically and/or continuously push information to OPP 113 to aid in the identification of movies of interest, or to provide other data and/or interactive features to the user through user equipment 108, e.g., through television widget 105.

FIG. 2 illustrates an example of generalized user equipment 200 that may be used to implement television widget 105 in accordance with some embodiments of the present invention. User equipment device 300 may receive and send information from service provider 102 and/or OPP 113 (FIG. 1) via input/output (hereinafter “I/O”) path 202. I/O path 202 may provide data to control circuitry 204, which may include processing circuitry 306 and storage 308. I/O path 302 may connect control circuitry 304 (and specifically processing circuitry 306) to one or more communication paths (described below). I/O functions may be provided by one or more of these communication paths, but are shown as a single path in FIG. 2 to avoid overcomplicating the drawing.

Control circuitry 204 may be based on any suitable processing circuitry 206 such as processing circuitry based on one or more microprocessors, microcontrollers, digital signal processors, programmable logic devices, etc. In some embodiments, control circuitry 204 executes instructions for television widget 105 or any other applications stored in memory (i.e., storage 208). In client-server based embodiments, control circuitry 204 may include communications circuitry suitable for communicating with networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 1). In addition, communications circuitry may include circuitry that enables peer-to-peer communication of user equipment devices, or communication of user equipment devices in locations remote from each other (described in more detail in connection with FIG. 1).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 208 that is part of control circuitry 204. Storage 208 may include one or more of the above types of storage devices. For example, user equipment device 300 may include a hard drive for a DVR (sometimes called a personal video recorder, or PVR) and a DVD recorder as a secondary storage device. Storage 208 may be used to store various types of media and data described herein, including program information, widget settings, user preferences or profile information, or other data used in operating television widget 105. Nonvolatile memory may also be used (e.g., to launch a boot-up routine and other instructions).

Control circuitry 204 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 204 may also include scaler circuitry for upconverting and downconverting media into the preferred output format of the user equipment 200. Circuitry 204 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive data for television widget 105. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc). If storage 208 is provided as a separate device from user equipment device 200, the tuning and encoding circuitry (including multiple tuners) may be associated with storage 208.

A user may control the control circuitry 204 using user input interface 210. User input interface 210 may be any suitable user interface, such as a remote control, mouse, trackball, keypad, keyboard, touch screen, touch pad, stylus input, joystick, voice recognition interface, or other user input interfaces. Display 212 may be provided as a stand-alone device or integrated with other elements of user equipment device 200. Display 212 may be one or more of a monitor, a television, a liquid crystal display (LCD) for a mobile device, or any other suitable equipment for displaying visual images. In some embodiments, display 212 may be HDTV-capable. Speakers 214 may be provided as integrated with other elements of user equipment device 200 or may be stand-alone units. The audio component of videos and other media content displayed on display 212 may be played through speakers 214. In some embodiments, the audio may be distributed to a receiver (not shown), which processes and outputs the audio via speakers 214.

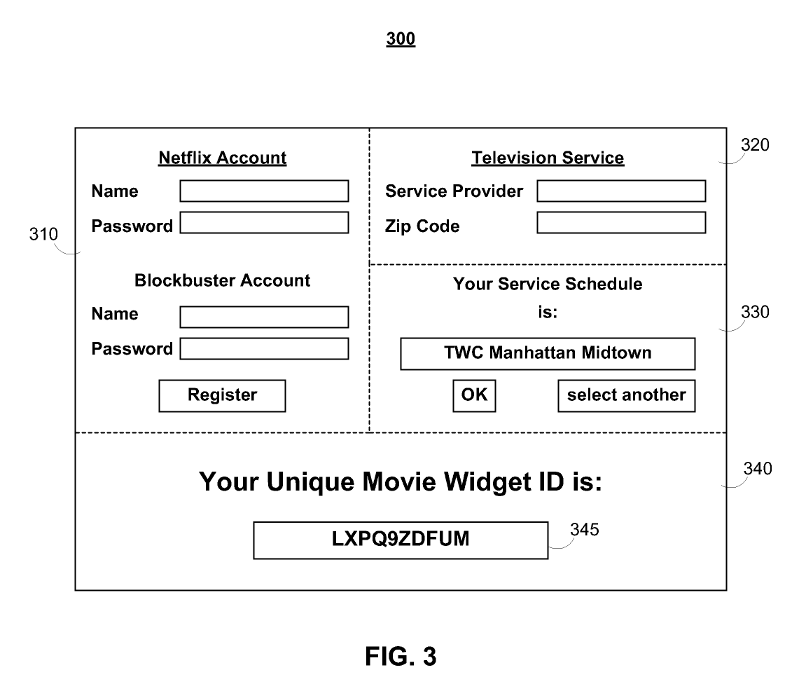

FIG. 3 illustrates an example of a profile setup screen 300 used to provide data and/or other interactive features to the user through the television widget in accordance with some embodiments of the present invention. Profile setup screen 300 may allow the user to enter and send profile information to OPP 113 (FIG. 1). This profile information may then be used to identify a movie of interest to the user—e.g., a movie title related to a commercial during which the user invoked television widget 105. Identification of a movie of interest using this profile information may bypass the need for service provider 102 to share information they have regarding a particular user with television widget 105. In some embodiments, information entered into profile setup screen 300 may be sent to OPP 113 and stored in databases 112. In other embodiments, information entered into profile setup screen 300 may be stored locally on user equipment 108, such as storage 202 (FIG. 2). Further, in some embodiments, profile setup screen 300 may be accessed by a user through television widget 105 (FIG. 1) itself. In other embodiments, profile setup screen 300 may be accessed by a user through user internet-enabled equipment 106, such as a mobile phone.

Profile setup screen 300 may include television service region 320. A user who is entering information into profile setup screen 300 may enter information into television service region 310 in order to aid television widget 105 in identifying a movie of interest to the user. For example, the user may provide information regarding their cable service provider and zip code in which they receive television service. This information may then be processed by OPP 113 to determine the exact cable service being provided to the user. In some embodiments, this information may include the name of the user's service provider, the user's zip code, and/or any other information that OPP 113 could use to determine a user's cable service provider.

Once a user's cable service is identified, OPP 113 and/or television widget 105 may be able to determine the exact movie commercial the user was watching when they invoked television widget 105 by identifying the programming schedule of the cable service. In some embodiments, this programming schedule may be monitored, either automatically (e.g., through video analysis of commercials) or manually (e.g., by manual viewing and tracking of commercials), by OPP 113 in order to determine what commercials were broadcast within a particular programming schedule. In other embodiments, the determination of the exact commercial the user was watching may be made based on information received by the advertiser itself, such as a movie studio. The information from the movie studio may be requested and/or received by OPP 113 from third party servers 122, such as studio promotion server 118. For example, Warner Brothers may inform OPP 113 that between the hours of 9 PM and 10 PM on channel 12 on an upcoming Wednesday, the movie “Batman Returns” will be advertised. This information may help OPP to narrow down which exact movie a user indicated interest in when they invoked television widget 105.

Further, profile setup screen 300 may also include service confirmation region 330. Service confirmation region 330 may allow the user to confirm what exact cable service is being provided to the user. Service confirmation region 330 may include a drop down box that displays a list of cable services related to a customer's zip code, such as “Time Warner Cable Midtown Manhattan” for zip code 10036 or “Comcast Digital Cable Pittsburgh” for zip code 15241. This list of cable services may be based on a search performed on the input the user entered in television service region 320. In some embodiments, the user may confirm whether the selected or displayed cable service corresponds to the cable service they use on their user equipment 108.

Profile setup screen 300 may include account region 310. A user who is entering information into profile setup screen 300 may enter information into account region 310 related to accounts they may have with third party proprietors of movie sales or rentals, cinema clubs, movie studio promotion wings, such as those proprietors who operate third party servers 122 (FIG. 1). The information entered into account region 310 may be used by television widget 105 and/or OPP 113 to log into third party servers 122, and consequently provide data and/or other interactive features to a user.

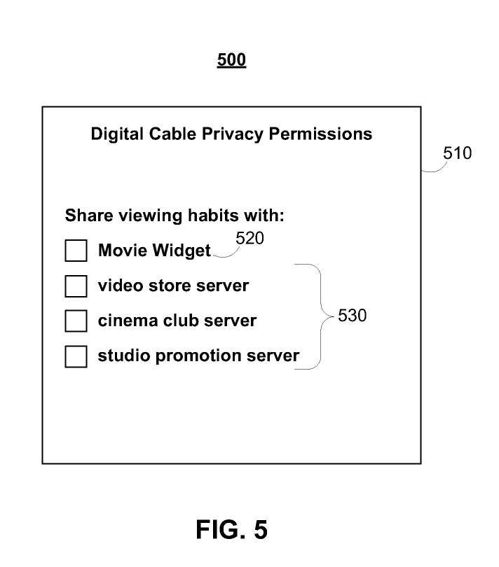

In some embodiments, account region 310 may provide the user with an option to integrate various profile information collected from profile setup screen 300 with profile information from accounts the user has with third parties, such as third party proprietors of movie sales or rentals, cinema clubs, and movie studio promotion wings. For example, the user may select an option to integrate profile information from their Netflix account stored on video store server 114 with profile information related to the user's service provider 102. When the user selects such an option, OPP 113 may request the user's Netflix profile information from video store server 114, and store the information at databases 112. OPP 113 may then integrate the Netflix account information with the user's profile information related to the user's service provider by, for example, storing both types of profile information in the same data structure associated with the user. In some embodiments, this integration may require the user to grant certain privacy permissions, such the permissions discussed below with respect to FIG. 5.

Profile setup screen 300 may also include widget ID region 340. Widget ID region 340 may display an identification code 345, a unique combination of letters and/or numbers assigned to the user of profile setup screen 300, that enables the user to coordinate their profile information with other devices related to the use of television widget 105, such as OPP 113, user entertainment equipment 104, and/or user internet-enabled equipment 106. In embodiments where profile setup screen 300 is accessed through television widget 105, identification code 345 may be assigned to a user as part of a login screen.

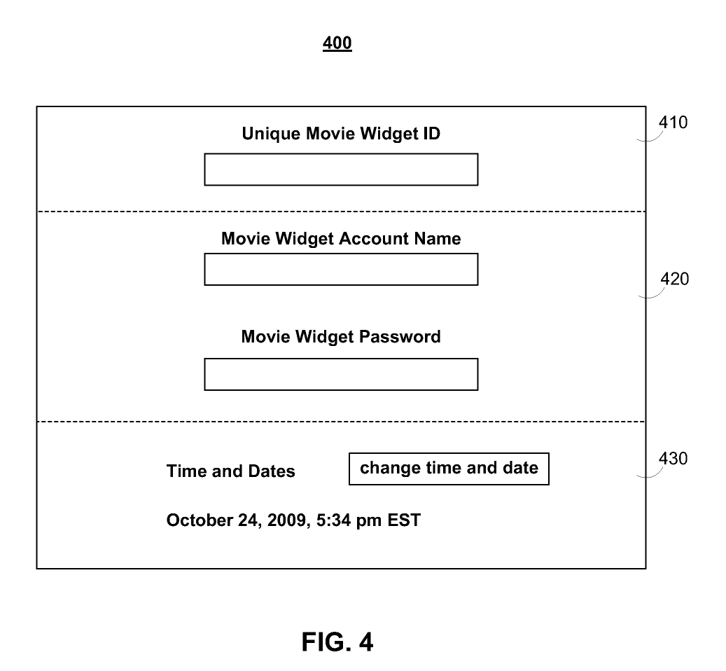

FIG. 4 illustrates an example of a login screen 400 used to provide data and/or other interactive features to the user through television widget 105 in accordance with some embodiments of the present invention. Widget login screen 400 may include widget ID region 410, login region 420, and clock settings region 430. Login region 420 may allow a user of television widget 105 to enter an login credentials of their choosing, or credentials assigned to them by OPP 113. Identification code 345 may be generated by television widget 105 the first time a user logs on to profile setup screen 300 using login screen 420, and displayed in widget ID region 410. In some embodiments, identification code 345 may be generated by the processor which implements television widget 105 (e.g., processing circuitry 206 of user equipment 200). Identification code 345 may then be stored in storage devices associated with the equipment that is running television widget 105 (e.g., storage 208 of user equipment 200 in FIG. 2). This storage may enable OPP 113 to determine the particular user equipment on which the user receives data and/or other interactive features related to the movie of interest. This login process may ensure that identification code 345 is unique to each user of television widget 105.

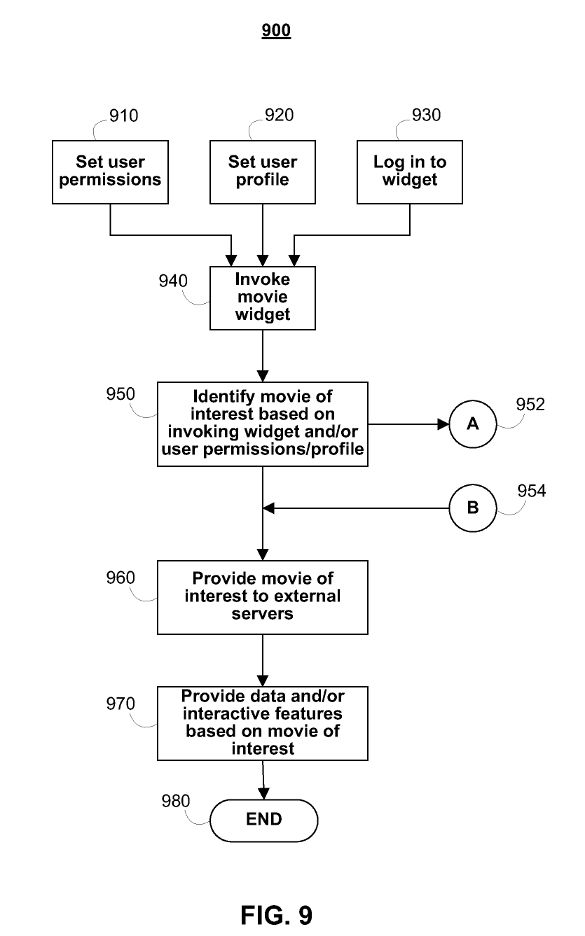

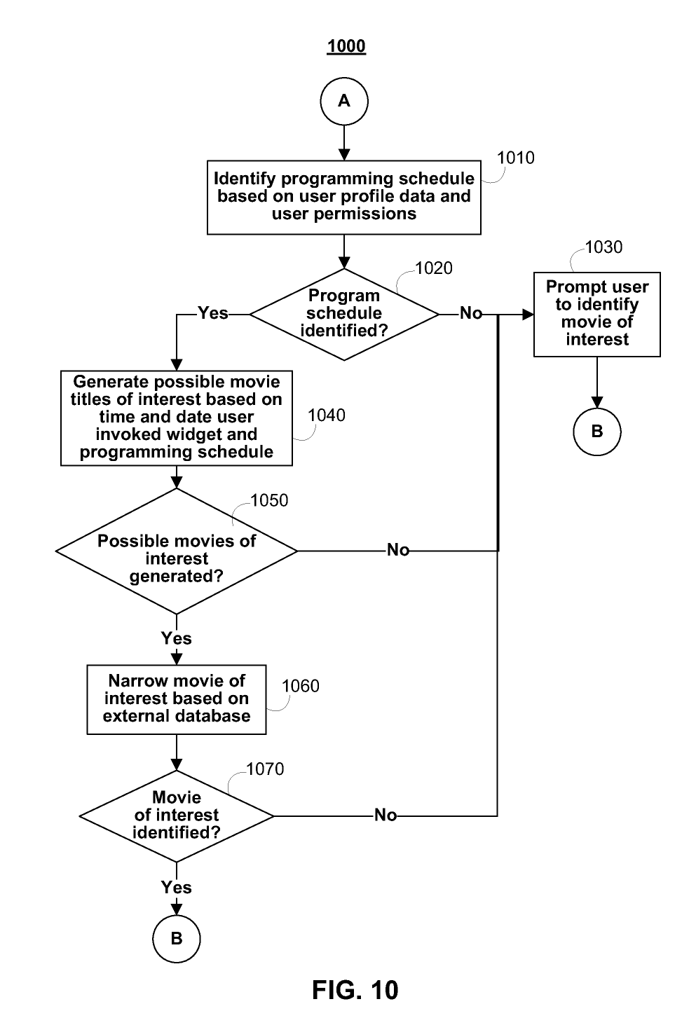

Clock settings region 430 may include the current time and date of television widget 105. In some embodiments, this information may include the time and date of the internal clock of the processor which runs television widget 105 (e.g., control circuitry 204 of user equipment 200 in FIG. 2). In some embodiments, the user may be able to adjust the current time and date, for example, by changing the time zone. It is important that the current time and date information be accurate, as it may be used to identify a movie of interest based on a user's interactions with television widget 105. For example, when the user invokes television widget 105 during a movie commercial, television widget 105 may send the user's identification code 345, the time and date the user invoked television widget 105, and the user's cable service (e.g., the cable service identified in profile setup screen 300). The time and date the user invoked television widget 105 may then be used along with the user's cable service to determine what ads were being shown on the user's cable service at that time and date. Once a list of possible advertisements are gathered, in some embodiments the exact movie may be identified by requesting the exact channel the user watching at that time and date they invoked television widget 105 from service provider 102 (FIG. 1). In other embodiments, television widget 105 may prompt the user for the channel they were watching when they invoked television widget 105. This resolution will be further described with respect to FIGS. 9 and 10.

Returning to FIG. 3, in embodiments where profile setup screen 300 is accessed through user internet-enabled equipment 106, identification code 345 may already be entered into or automatically populated in widget ID region 340. For example, identification code 345 may have been assigned to a user of television widget 105 during the login process described above. When the user accesses profile setup screen 300 through internet-enabled equipment 106, they may enter the widget ID assigned to them through television widget 105. Providing the widget ID in widget ID region 340 of profile setup screen 300 on user internet-enabled equipment 106 may tie or integrate the equipment into the system of television widget 105 (e.g., system 100 of FIG. 1). This integration may allow user internet-enabled equipment 106 to be delivered data and/or other interactive features related to the user's interaction with television widget 105. In some embodiments, OPP 113 may route data and/or other interactive features related to the user's interaction with television widget 105 to the user equipment associated with identification code 345 (e.g., the user equipment on which identification code 345 is stored). This integration is beneficial to the user, as it allows the use any device they wish while still being provided with the data and/or other interactive features related to the user's interaction with television widget 105. Accordingly, identification code 345 may allow television widget 105 to be platform-agnostic.

FIG. 5 illustrates an example of a user permissions screen 500 used to provide data and/or other interactive features to the user through television widget 105 in accordance with some embodiments of the present invention. User permissions screen 500 may allow a user of television widget 105 to access permissions set 510, which includes permissions that aid or enable television widget 105 to deliver data and/or other interactive features to the user. The user may grant or deny the permissions in permissions set 510 according to their personal preferences. In the embodiment illustrated in FIG. 5, permissions set 510 relates to permissions from the point of view of the user's service provider 102. In other embodiments, permissions set 510 may relate to permissions from the point of view of OPP 113, third party servers 122, and user equipment 108, including television widget 105 itself. As described above with respect to FIG. 1, permissions set 510 may be stored remotely from user equipment 108 (e.g., in databases 112 or in databases or servers in service provider 102), or may be stored locally on user equipment 108 (e.g., in storage 208 of user equipment 200).

Permissions set 510 may include widget permissions 520, which may allow the user to share their viewing habits with television widget 105. If widget permissions 520 is selected, service provider 102 may continuously and/or periodically provide OPP 113 with the channel that a user is watching on the user equipment running television widget 105. OPP 113 may then use this information, along with the time and date the user invoked the movie widget and the cable service being provided to the user, to determine the exact movie commercial the user was watching when they invoked television widget 105. In some embodiments, OPP 113 may request that service provider 102 identify the channel watched by a particular user at a particular date and time. OPP 113 may identify the user in this request by sending service provider 102 identification code 345. As a result of this request, service provider 102 may examine widget permissions 520 for that particular user, and then reply to OPP 113 with the channel if widget permissions 520 have been granted.

In some embodiments, widget permissions 520 may provide the user with the opportunity to allow their viewing habits to be stored on OPP 113, or in databases 112. In embodiments where permissions information is stored at OPP 113 or databases 112, widget permissions 520 may provide the user with the opportunity to allow their viewing habits to be shared directly with OPP 113 rather than OPP 113 requesting this information from service provider 102.

Permissions set 510 may also include third party server permissions 530, which may allow the user to share their viewing habits with third party servers 122 (FIG. 1). If third party server permissions 530 are selected, OPP 113 may continuously and/or periodically send information regarding a user's viewing habits to third party servers 122. In such embodiments, it is presumed that OPP 113 has access to these viewing habits, either through permissions from the user, agreements with service provider 102, and/or information sent directly from the user. Third party servers 122 may then use this information, along with other information processed by OPP 113 and/or stored in databases 112, to provide data and/or other interactive features to the user.

In an embodiment, video store server 114 may request information regarding the user's viewing habits from OPP 113 in order to build a user profile relating to the movies the user indicated interest in. Assuming that the user has granted the appropriate permission in third party server permissions 530, OPP 113 may pass on recommendations from video store server 114 for DVD rentals to the user based on their interaction with television widget 105, profile information stored in databases 112, and DVD rental inventory from video store server 114.

In an embodiment, cinema club server 116 may request information regarding the user's viewing habits from OPP 113 in order to provide the user with information regarding movie times and special events related to a movie the user has indicated interest in. Assuming that the user has granted the appropriate permission in third party server permissions 530, OPP 113 may pass on information regarding movie times and special events related to the movie the user has indicated interest in.

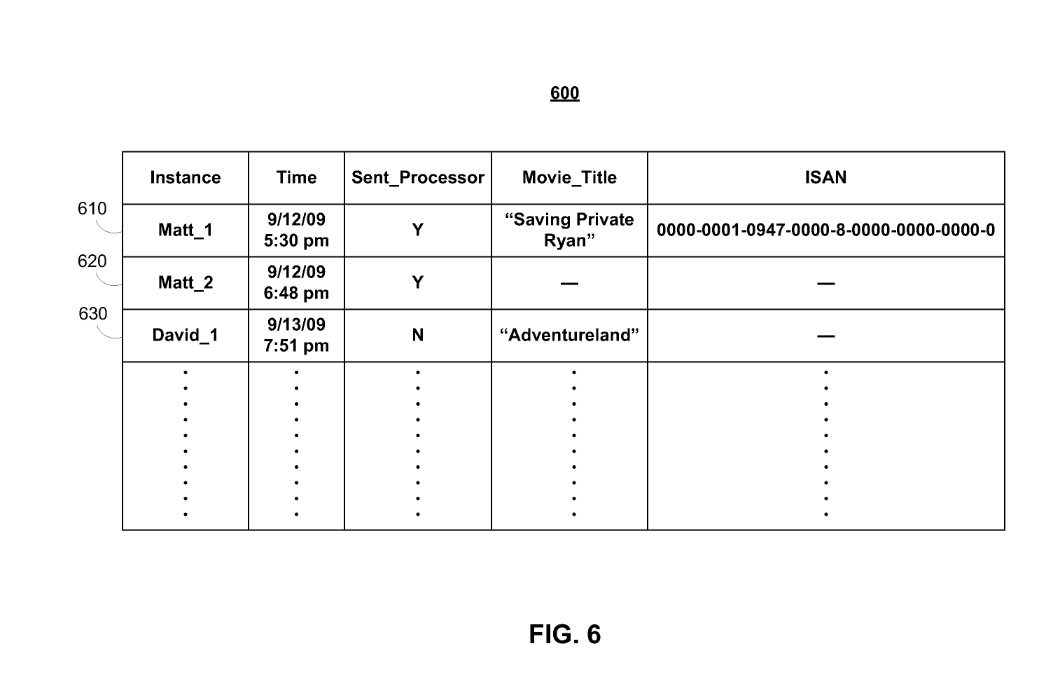

FIG. 6 illustrates an example of user viewing data 600 in accordance with some embodiments of the invention. Preferably, viewing data 600 is collected and stored by OPP 113 in databases 112. This storage arrangement allows for OPP 113 to directly track movies of interest based on users' interactions with television widget 105. Alternatively, viewing data 600 may be collected and stored on user equipment 108 (e.g., storage of user entertainment equipment 104) or at storage located at service provider 102.

Viewing data 600 may include data sets 610, 620, and 630 related to instances of a user invoking a widget. As shown in FIG. 6, these instances may be identified by unique character strings that contain the particular user that invoked television widget 105, assuming that the widget is able to determine the particular user based on a logon process as described above with respect to FIG. 4. The strings may also contain a number indicating whether the particular instance is the first, second, third, or nth time the user has invoked television widget 105. For example, data set 610 may be identified as “Matt_1”, indicating that it is the first instance of user “Matt” invoking television widget 105. Depending on system constraints on the length of these strings, the numbers identifying the instances may reset or wrap after a particular number. Viewing data 600 may also include a time and date field reflecting the exact time and date that a user invoked television widget 105. As described above with respect to FIG. 4, this time and date may be generated from the internal time and date of the clock of the processor which runs television widget 105 (e.g., control circuitry 204 of user equipment 200 in FIG. 2). In embodiments where viewing data 600 is not managed by OPP 113, viewing data 600 may include a field that reflects whether the information regarding a particular instance has been sent to OPP 113 for resolution. This field may be useful in aiding television widget 105 to determine if it is necessary to ping OPP 113 in order to identify a movie of interest.

Viewing data 600 may also include fields for a title of the movie of interest itself, as well as any other identification fields that may be necessary to identify the movie of interest. These other fields may be helpful in identifying the movie of interest because movie titles are not unique—for example, there are three movies with the title “Crazy in Love” made in 1987, 2004, and 2007. Accordingly, in some embodiments, in order to determine the exact movie that the user is interested in, an International Standard Audiovisual Number (hereinafter “ISAN”) may be assigned to an instance along with the movie title. The ISAN may be retrieved from a search of one of third party servers 122, or using any other suitable resolution means. In some instances, the ISAN combined with the movie title still may not be able to fully identify the movie of interest, and additional searches of third party servers 122 may be necessary. These third party servers may include other servers 120, such as imdb.com. In some embodiments, the information from these additional searches may be used instead of the ISAN number. In other words, an identifier for the movie other than an ISAN may be used to help determine the exact movie of interest. For example, the system may use a url for the particular movie from imdb.com, or a stock-keeping unit (“SKU”) in place of the ISAN to help determine the exact movie of interest.

Each field may be a character string, an integer, a Boolean, or any suitable data structure. These metadata fields are illustrative in that they may include any number of suitable fields, including 1, 2, 5, 10, 15, 20, 50, or more than 50 metadata fields. In some embodiments, data set 610, 620, and 630 may have missing and/or incomplete data fields. For example, data set 620 is missing the movie title and ISAN related to the movie of interest in instance “Matt_2”.

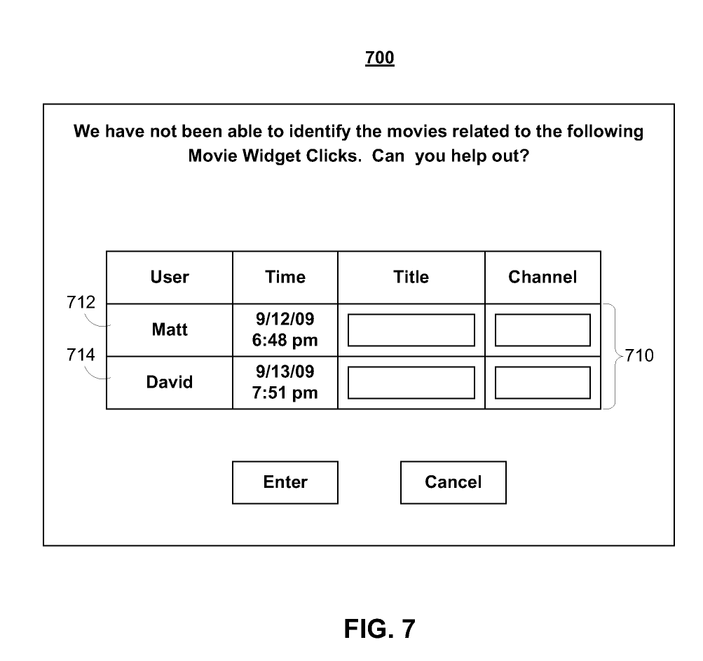

FIG. 7 illustrates an example of a user identification screen 700 used to aid the television widget in identifying a movie of interest in accordance with some embodiments of the present invention. User identification screen 700 may be displayed when television widget 105, using the available resources of system 100 (FIG. 1), cannot identify a movie title of interest of interest. This display may be automatic or due to user interaction (e.g., navigation) within television widget 105 itself. As shown in FIG. 7, user identification screen 700 may include identification area 710, and include various fields similar to those described above with respect to FIG. 6. For example, identification area 710 may include prompts 712 and 714. These prompts may be associated with data sets 620 and 630, respectively, in which the particular movie titles of the movies of interest could not be identified. For example, prompts 712 and 714 may ask the users “Matt” and “David” to identify the title of the movie related to a movie advertisement and channel that the movie advertisement was playing on when Matt and David invoked television widget 105. In embodiments where user identification screen 700 is displayed on the same user equipment as television widget 105, certain prompts may be omitted when a particular user has logged into television widget 105. For example, when user “Matt” is logged into television widget 105, prompt 714 may not be displayed. Once the user has entered information into identification area 710, this information may be sent to OPP 113 and stored in databases 112. Alternatively, this information may be stored at service provider 102, or locally at user equipment 108.

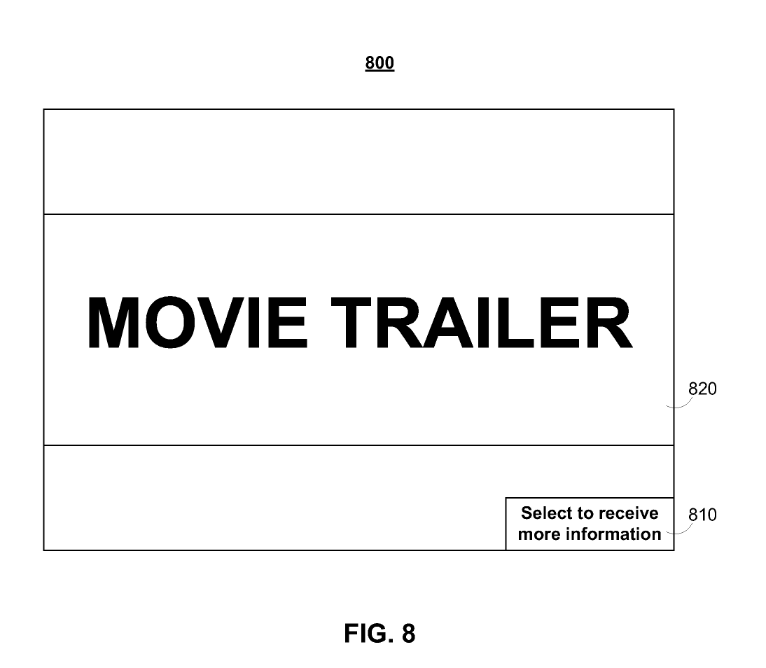

FIG. 8 illustrates an example of a television widget notification screen 800 in accordance with some embodiments of the present invention. Widget notification screen 800 may include widget graphic 810, which may include any suitable text and/or graphics and/or video that indicates to the user that television widget 105 may be invoked. Widget graphic 810 may be displayed whenever television widget 105 is enabled to run on user equipment 108. For example, television widget 105 may be displayed when the widget is downloaded and/or installed on user entertainment equipment 104. In some embodiments, widget graphic 810 may be integrated into an interactive graphical display with other widgets, such as the TV Widget dock of Yahoo! Connected TV.

FIG. 9 illustrates a flow chart of a process 900 for providing data and/or other interactive features based on user interaction with a television widget in accordance with some embodiments of the present invention. Process 900 may start at any combination of steps 910, 920, or 930. At step 910, user permissions are set. These permissions may include any of the permissions discussed with respect to user permissions screen 500 (FIG. 5). As described above with respect to FIG. 1, these permissions may be stored remotely from user equipment 108 (e.g., in databases 112 or in databases or servers in service provider 102), or may be stored locally on user equipment 108 (e.g., in storage 208 of user equipment 200). At step 920, a user profile is set. The information in the user profile may be accessed, stored, and/or managed substantially similar to the embodiments described with respect to profile setup screen 300 (FIG. 3). At step 930, the user logs into television widget 105. This login process may be managed substantially similar to that described with respect to login screen 400 (FIG. 4). In some embodiments, completion of the login process may cause television widget 105 to begin running on user equipment 108 (FIG. 1). In other embodiments, television widget 105 may run regardless of completion of the login process. In some embodiments, the user may input the information related to steps 910, 920 and/or 930 in television widget 105 using user equipment 108. This information may then be sent to OPP 113, who receives the information and uses it to identify the movie of interest later in process 900.

If at least one of steps 910, 920, and/or 930 has been completed, process 900 proceeds to step 940. At step 940, a user invokes television widget 105. A user may invoke television widget 105 during the broadcast of a television commercial to indicate a movie of interest—e.g., a movie being advertised in a broadcast television commercial that the user is interested in. Invoking television widget 105 may be achieved through any suitable user input means, such as pressing a button on a remote controller, and/or navigating to and selecting a particular portion of the screen (e.g., widget notification screen 800 described with respect to FIG. 8). In some embodiments, the television widget may be invoked through user equipment 108 (FIG. 1), and the input means may be substantially similar to those described with respect to user input interface 210 (FIG. 2). Once the user has invoked television widget 105, process 900 proceeds to step 950.

At step 950, the movie of interest is identified based on the user invoking television widget 105 and/or information entered at steps 910, 920, and/or 930. For example, OPP may receive a user's identification code 345, the time and date the user invoked television widget 105, and the user's cable service. Identification of a user's cable service may be substantially similar to the steps described with respect to profile setup screen 300 (FIG. 3) and will be discussed in further detail below with regards to FIG. 10. The time and date the user invoked television widget 105 may then be used along with the user's cable service to determine what ads were being shown on the user's cable service at that time and date. This determination may be made using any suitable search of the commercials broadcast during a particular programming schedule related to the time and date the user invoked television widget 105—for example, a standard programming block of a half hour, hour, two hours, or any suitable programming block. As described above with respect to FIG. 3, this programming schedule may be monitored, either automatically (e.g., through video analysis of commercials) or manually (e.g., by manual viewing and tracking of commercials), by OPP 113 in order to determine what commercials were broadcast within a particular programming schedule. In other embodiments, the possible ads the user was watching may be determined based on information received by the advertiser itself, such as a movie studio. The information from the movie studio may be requested and/or received by OPP 113 from third party servers 122, such as studio promotion server 118. For example, Warner Brothers may inform OPP 113 that between the hours of 9 PM and 10 PM on channel 12 on an upcoming Wednesday, the movie “Batman Returns” will be advertised. This information may help OPP to generate a list of identifiers related to the movie a user indicated interest in when they invoked television widget 105.

Once a list of possible commercials and/or movie identifiers are gathered, in some embodiments the movie of interest may be identified by requesting the exact channel the user watching at that time and date they invoked television widget 105 from service provider 102 (FIG. 1). This request may be negotiated by permissions set at step 910. In other embodiments, television widget 105 may prompt the user for the channel they were watching when they invoked television widget 105, such as the prompts described with respect to user identification screen 700 (FIG. 7). Finally, if such efforts still do not identify the movie of interest, a search of an external database may be performed as described below with respect to FIG. 10. In some embodiments, additional steps may be required to identify the movie title of interest. These additional steps may be performed at step 952 as described with respect to process 1000, which returns to process 900 at step 954. Once the movie of interest has been identified, process 900 proceeds to step 960.

At step 960, the movie of interest may be provided to external servers, such as third party servers 122. This data may be sent to external servers based on user permissions set at step 910. For example, the user may set a permission that allows their interest in movie commercials to be communicated with cinema club servers. If such a permission is set, an identifier relating to a movie of interest identified at step 950 may be sent to cinema club server 116. Process 900 may then proceed to step 970.

At step 970, data and/or other interactive features may be provided based on the movie of interest sent to external servers, such as third party servers 122. This data and/or other interactive features may be substantially similar to those described with respect to video store server 114, cinema club server 116, studio promotion server 118, and other servers 120 in the description of FIG. 1. In some embodiments, this data and/or other interactive features may be provided in the form of visual information (e.g., text and/or pictures and/or video) delivered to user equipment 108 and displayed in television widget 105. In other embodiments, this visual information may be provided to the user through particular features of user equipment 108 outside of the functionality of television widget 105.

FIG. 10 illustrates a flow chart of a process 1000 for identifying a movie of interest based on user interaction with a television widget in accordance with some embodiments of the present invention. Process 1000 begins at step 1010. At step 1010, the programming schedule the user watched during the broadcast of the movie commercial they indicated an interest in by invoking television widget 105 may be identified. In order to determine the exact commercial the user was watching when they invoked television widget 105, the user's cable service may be determined. This determination may be achieved by gathering profile information, such as the information described with respect to profile setup screen 300 (FIG. 3). For example, the user may enter information into television widget 105 to confirm what exact cable service they subscribe to or are provided with at their user equipment 108. As described with respect to service confirmation region 330 (FIG. 3), a drop down box may display a list of cable services related to a customer's zip code. This list of cable services may be based on a search performed on the input the user entered in television service region 320. This search may be performed on a cable service database maintained by OPP 113 at databases 112, or at storage in service provider 102. In some embodiments, the user may confirm whether the selected or displayed cable service corresponds to the cable service they use on their user equipment 108. Process 1000 may then proceed to step 1020.

At step 1020, it is determined whether the programming schedule has been identified. If the programming schedule has not been identified, process 1000 proceeds to step 1030. If the programming schedule has been identified, programming schedule may proceed to step 1040.

At step 1030, the user may be prompted to identify the movie of interest because the system was not able to identify what movie the user was indicating interest in when they invoked television widget 105. The user may then be prompted to enter information such as that described with respect to user identification screen 700 (FIG. 7). This user generated information, including the movie title itself, may be sent to OPP 113 for further processing. Process 1000 then proceeds to step B (step 954 of process 900 in FIG. 9) and ends.

At step 1040, movie titles that the user was possibly interested in when they invoked television widget 105 are generated. These movie titles may be generated based on the exact time and date the user invoked television widget 105, as well as the programming schedule identified in step 1020. For example, the time and date the user invoked television widget 105 may be correlated with a list of advertisements generated based on information related to the user's cable service. In some embodiments, this correlation may be executed without regard to the particular television channel the user was watching when they invoked television widget 105, generating a list of all advertisements being shown to the programming schedule available to the user at that date and time. Once a list of possible advertisements are generated, the movie of interest may be identified by requesting the exact channel the user watching at the time and date they invoked television widget 105 from service provider 102 (FIG. 1). In other embodiments, television widget 105 may prompt the user for the channel they were watching when they invoked television widget 105—for example, using user identification screen 700 (FIG. 7). In some embodiments, an identifier may be generated based on the exact movie—for example, a title or an ISAN. Process 1050 may then proceed to step 1050.

At step 1050, it is determined whether the movie of interest or a list of possible movies of interest was generated and/or identified at step 1040. If movie(s) of interest has not been identified, process 1000 proceeds to step 1030. If movie(s) have been identified, programming schedule may proceed to step 1060.

At step 1060, the movie of interest is narrowed (i.e., pinpointed) based on an a search of an external database, such as those databases located at third party servers 122 (FIG. 1). In some embodiments, step 1060 may not be necessary as the exact movie of interest is already known. However, it is possible that even though an identifier associated with the movie of interest has been identified, the exact movie the user was interested in is not identified. For example, movie titles are not unique—for example, there are three movies with the title “Crazy in Love” made in 1987, 2004, and 2007. Accordingly, the user may search an external database, such as imdb.com, in order to determine the exact movie the user was interested in. In some embodiments, the system will identify the movie of interest automatically, for example, by choosing the movie with the most current data—for example, the system may choose the production of “Crazy in Love” made in 2007 instead of 1987. In other embodiments, the system may identify the movie of interest by prompting the user to select between several possible productions of the movie—e.g., the three different productions of “Crazy in Love.” This resolution may occur at OPP 113, user equipment 108, or the servers housing the external databases themselves (e.g., third party servers 122). Process 1000 may then proceed to step 1070.

At step 1070, it is determined whether the movie of interest was identified at step 1060. If the movie of interest has been identified, process 1000 proceeds to step B (step 954 of process 900 in FIG. 9) and ends. If the programming schedule has not been identified, programming schedule may proceed to step 1030.

It is to be understood that while certain forms of the present invention have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein.

1. A method for providing at least one of data and interactive features to a user related to a movie of interest from interaction with a television widget, the method comprising:
receiving a first indication that the user invoked the television widget during a broadcast of a movie commercial;
receiving a second indication of the programming schedule the user watched during the broadcast of the movie commercial;
identifying the movie of interest based on the first and second indication; and
providing at least one of data and interactive features to the user based on the movie of interest.

2. The method of claim 1, wherein providing at least one of data and interactive features to the user based on the movie of interest comprises:
transmitting an identifier related to the movie title of interest to a third party server based on at least one user permission; and
providing at least one of data and interactive features to the user based on a response from the third party server.

3. The method of claim 1, wherein the first indication comprises a time and date of the internal clock of a processor running the television widget.

4. The method of claim 1, wherein the second indication comprises at least one of a television channel the user was watching when they invoked the television widget, a zip code in which the user is delivered the programming schedule, and a user selected identifier related to the programming schedule.

5. The method of claim 4, wherein identifying the movie of interest further comprises:
generating a list of the commercials broadcast within the programming schedule based on the second indication;
determining an identifier related to the movie of interest by correlating the first identifier with the list.

6. The method of claim 1, wherein a portion of at least one of the first and second indication is user generated.

7. The method of claim 1, wherein receiving a second indication of the programming schedule the user watched during the broadcast of the movie commercial further comprises prompting the user to enter information related to a cable service provider of the programming schedule.

8. The method of claim 1, further comprising:
prompting the user to enter profile information related to the second indication; and
generating the second indication based on the profile information.

9. The method of claim 1, further comprising:
prompting the user to provide login credentials to the television widget;
assigning a unique identification code to the user based on the login credentials;
associating the first indication and the second indication with the unique identification code; and
routing the data and/or other interactive features to the user based on unique identification code.

10. The method of claim 1, wherein the television widget is platform-agnostic.

11. A system for providing at least one of data and interactive features to a user related to a movie of interest from interaction with a television widget running on a user equipment, the system comprising an outside provider processor configured to:
receive a first indication that the user invoked the television widget during a broadcast of a movie commercial;
receive a second indication of the programming schedule the user watched during the broadcast of the movie commercial;
identify the movie of interest based on the first and second indication;
provide at least one of data and interactive features based on the movie of interest.

12. The system of claim 11, wherein the outside provider processor provides data and/or other interactive features to the user based on the movie of interest by further being configured to:
transmit an identifier related to the movie of interest to a third party server based on at least one user permission; and
provide at least one of data and interactive features to the user based on a response from the third party server.

13. The system of claim 11, wherein the first indication comprises a time and date of the internal clock of a processor running the television widget.

14. The system of claim 11, wherein the second indication comprises at least one of a television channel the user was watching when they invoked the television widget, a zip code in which the user is delivered the programming schedule, and a user selected identifier related to the programming schedule.

15. The system of claim 14, wherein the outside provider processor identifies the movie of interest by further being configured to:
generate a list of the commercials broadcast within the programming schedule based on the second indication;
determine an identifier related to the movie of interest by correlating the first identifier with the list.

16. The system of claim 11, wherein a portion of at least one of the first and second indication is user generated.

17. The system of claim 11, wherein the television widget is configured to prompt the user to enter information related to a cable service provider of the programming schedule.

18. The system of claim 11, wherein the television widget is configured to:
prompt the user to enter profile information related to the second indication; and
generate the second indication based on the profile information.

19. The system of claim 11, wherein the television widget is configured to:
prompt the user to provide login credentials to the television widget;
assign a unique identification code to the user based on the login credentials;
and wherein the outside provider processor is further configured to:
associate the first indication and the second indication with the unique identification code; and
route the data and/or other interactive features to the user based on unique identification code.

20. The system of claim 11, wherein the television widget is platform-agnostic.

21-30. (canceled)
